(19) United States
(12) Patent Application Publication
(10) Pub. No.: US 2025/0233490 A1
(43) Pub. Date: Jul. 17, 2025

(54) TURBOCHARGER WITH INSULATOR

(71) Applicants: IHI Corporation, Tokyo (JP); NHK SPRING CO., LTD., Yokohama-shi (JP)

(72) Inventors: Yoshihito KATSU, Tokyo (JP); Shun NAKAYAMA, Tokyo (JP); Yuji SASAKI, Tokyo (JP); Keiichi ITO, Yokohama-shi (JP); Naruhiko NISHIWAKI, Yokohama-shi (JP)

(21) Appl. No.: 19/058,015

(22) Filed: Feb. 20, 2025

Related U.S. Application Data
(63) Continuation of application No. PCT/JP2023/030596, filed on Aug. 24, 2023.

(30) Foreign Application Priority Data
Sep. 29, 2022 (JP) 2022-156036

(51) Int. Cl. H02K 11/25; F02B 39/10; H02K 3/52

(52) U.S. Cl. CPC H02K 11/25; F02B 39/10; H02K 3/522; H02K 2203/09; H02K 2203/12; H02K 2203/15

(57) ABSTRACT

An example turbocharger includes a turbine impeller, a rotation shaft fixed to the turbine impeller, a motor having a rotor located on the rotation shaft, and a stator located around the rotor. The stator includes a stator core, an insulator located around the stator core. The insulator includes an element pocket, a coil wound around the insulator. The coil includes a first coil end and a second coil end, and a temperature sensing device configured to detect a temperature of the coil. The temperature sensing device is located in the element pocket and hold by the element pocket.

### CROSS-REFERENCE TO RELATED APPLICATIONS

This application is a continuation application of PCT Application No. PCT/JP2023/030596, filed on Aug. 24, 2023, which claims the benefit of priority from Japanese Patent Application No. 2022-156036, filed on Sep. 29, 2022. The entire contents of the above listed PCT and priority applications are incorporated herein by reference.

### BACKGROUND

### Field

The present disclosure relates to a turbocharger.

### Description of the Related Art

Japanese Patent No. 5333657 discloses a turbocharger including a motor, when the torque of a rotation shaft provided by a turbine is insufficient, the motor applies torque to the rotation shaft so as to compensate for the insufficiency. In a motor thus built in a turbocharger, temperature control is needed in order to prevent a malfunction of the coil due to heat.

### SUMMARY

In a motor having a thermistor which is attached to a coil end of a stator by using a predetermined attachment component, in addition to the installation space for the thermistor, also the installation space for the attachment component itself is needed. Therefore, the space in the stator is contracted, and downsizing of the stator is hindered.

Disclosed herein is an example turbocharger including: an assist motor assembly having a rotor provided on a rotation shaft coupling a turbine impeller and a compressor wheel, and a stator provided around the rotor. The stator includes: a stator core; an insulator provided around the stator core; a coil wound around the insulator; a bus bar connected to one coil end portion located on an inner peripheral side out of both end portions of the coil; and a temperature measurement unit including a temperature-sensitive element unit configured to detect a temperature of the coil and a signal cable drawn out from the temperature-sensitive element unit. The temperature-sensitive element unit is inserted into an element pocket provided in the insulator in a rotation axis direction of the assist motor assembly, and the signal cable is drawn out from the temperature-sensitive element unit in a direction opposite to a direction of insertion of the temperature-sensitive element unit into the element pocket and extends to cross a side of the temperature-sensitive element unit of the bus bar as viewed from the rotation axis direction.

### BRIEF DESCRIPTION OF THE DRAWINGS

FIG. 1 is a cross-sectional view of an example turbocharger.

FIG. 2A illustrates an example component group of a stator.

FIG. 2B illustrates another example component group of the stator partially illustrated in FIG. 2A.

FIG. 2C illustrates yet another example component group of the stator partially illustrated in FIGS. 2A and 2B.

FIG. 3A illustrates an example component group of a stator.

FIG. 3B illustrates another example component group of the stator partially illustrated in FIG. 3A.

FIG. 3C illustrates yet another example component group of the stator partially illustrated in FIGS. 3A and 3B.

FIG. 4 is an example circuit diagram of a stator.

FIG. 5A is a perspective view illustrating an electromagnet assembly in which a thermistor is installed.

FIG. 5B is a perspective view illustrating a state where a coil is removed from the electromagnet assembly of FIG. 5A.

FIG. 6 is a cross-sectional view taken along line VI-VI in FIG. 5B.

FIG. 7 is an enlarged view of the vicinity of a thermistor in a stator immediately before fixing by resin molding is performed, as viewed in an axial direction from a compressor side.

### DETAILED DESCRIPTION

Some examples of turbochargers are as follows [1] to [6].

[1] An example turbocharger includes: an assist motor assembly including a rotor provided on a rotation shaft coupling a turbine impeller and a compressor wheel, and a stator provided around the rotor. The stator includes: a stator core; an insulator provided around the stator core; a coil wound around the insulator; a bus bar connected to one coil end portion located on an inner peripheral side out of both end portions of the coil; and a temperature measurement unit including a temperature-sensitive element unit configured to detect a temperature of the coil and a signal cable drawn out from the temperature-sensitive element unit. The temperature-sensitive element unit is inserted into an element pocket provided in the insulator in a rotation axis direction of the assist motor assembly, and the signal cable is drawn out from the temperature-sensitive element unit in a direction opposite to a direction of insertion of the temperature-sensitive element unit into the element pocket and extends to cross a side of the temperature-sensitive element unit of the bus bar as viewed from the rotation axis direction.

[2] In the turbocharger disclosed in [1], the bus bar may extend from an insulating material present more on an outer peripheral side than the coil end portion to an inner peripheral side in a radial direction and is connected to the coil end portion, and a portion of the signal cable between a portion crossing the bus bar and a cable end portion drawn out to an outside of the stator may be fitted into a groove formed in the insulating material.

[3] In the turbocharger disclosed in [1] or [2], a plurality of electromagnet assemblies each including the stator core, the insulator, and the coil may be arranged in a circumferential direction. The bus bar may extend in a radial direction in a position between two of the electromagnet assemblies adjacent as viewed from an axial direction. Both of two signal cables drawn out from the temperature-sensitive element unit may be drawn out from the temperature-sensitive element unit in a direction opposite to a direction of insertion of the temperature-sensitive element unit into the element pocket, and may extend to cross the bus bar as viewed from the rotation axis direction and pass through a side of the temperature-sensitive element unit of the bus bar.

[4] In the turbocharger disclosed in any one of [1] to [3], the coil end portion may extend in an axial direction, and may be located adjacent in a circumferential direction to the temperature-sensitive element unit in the element pocket.

[5] In the turbocharger disclosed in any one of [1] to [4], a mold resin is present between the temperature-sensitive element unit and the coil, the mold resin filling a space therebetween.

[6] In the turbocharger disclosed in any one of [1] to [5], a gap for exposing part of the temperature-sensitive element unit in the element pocket may be formed in the element pocket, and the coil and the temperature-sensitive element unit may be close to each other through the gap.

In the following description, with reference to the drawings, the same reference numbers are assigned to the same components or to similar components having the same function, and overlapping description is omitted.

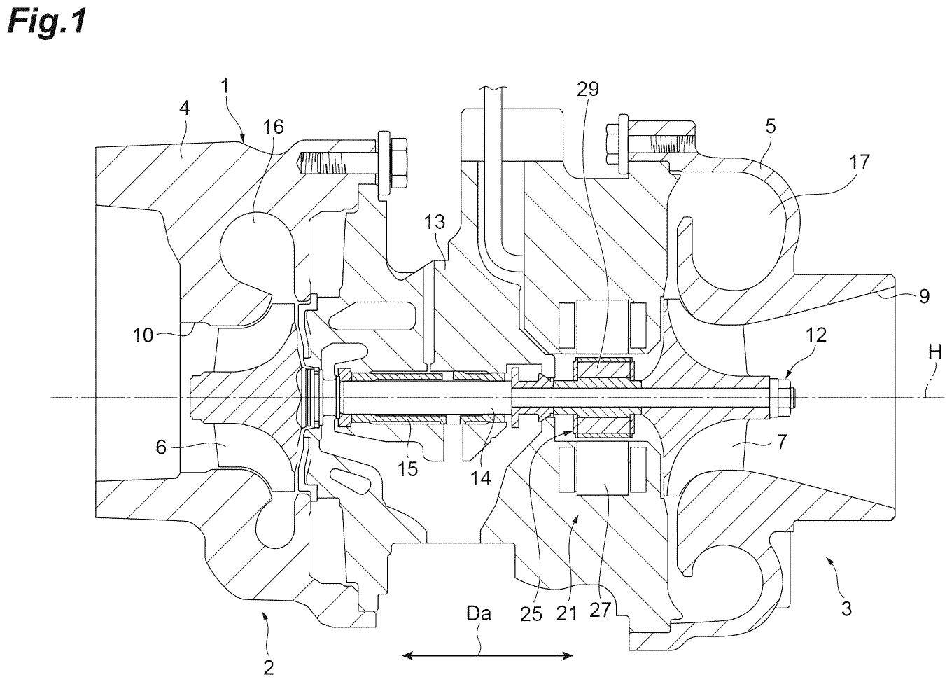

FIG. 1 is a cross-sectional view illustrating a cross section including a rotation axis H of an example turbocharger 1. In the following description, simple terms of “axial direction”, “radial direction”, and “circumferential direction” mean the axial direction, the radial direction, and the circumferential direction of a rotation shaft 14 described later, respectively. Further, a simple term of “outer peripheral side/inner peripheral side” means the outer side/inner side in the radial direction of the rotation shaft 14. The term “rotation axis direction” is an example of “axial direction.”.

The turbocharger 1 is used for an internal combustion engine of a vehicle or the like. As shown in FIG. 1, the turbocharger 1 includes a turbine 2 and a compressor 3. The turbine 2 includes a turbine housing 4 and a turbine wheel 6 housed in the turbine housing 4. The turbine housing 4 has a scroll flow path 16 extending in the circumferential direction Dc around the turbine wheel 6. The compressor 3 includes a compressor housing 5 and a compressor wheel 7 housed in the compressor housing 5. The compressor housing 5 has a scroll flow path 17 extending in the circumferential direction Dc around the compressor wheel 7.

The turbine wheel 6 is provided at one end of a rotation shaft 14, and the compressor wheel 7 is provided at the other end of the rotation shaft 14. A bearing housing 13 is provided between the turbine housing 4 and the compressor housing 5. The rotation shaft 14 is rotatably supported by the bearing housing 13 via a bearing 15, and the rotation shaft 14, the turbine wheel 6, and the compressor wheel 7 rotate about the rotation axis H as an integrated rotating body 12.

The turbine housing 4 is provided with an exhaust gas inlet and an exhaust gas outlet 10. Exhaust gas discharged from an internal combustion engine flows into the turbine housing 4 through the exhaust gas inlet. After that, the exhaust gas flows into the turbine wheel 6 through the scroll flow path 16, and rotates the turbine wheel 6. After that, the exhaust gas flows out to the outside of the turbine housing 4 through the exhaust gas outlet 10.

The compressor housing 5 is provided with a suction port 9 and a discharge port. When the turbine wheel 6 rotates as described above, the compressor wheel 7 rotates via the rotation shaft 14. The rotating compressor wheel 7 sucks external air through the suction port 9. This air passes through the compressor wheel 7 and the scroll flow path 17 to be compressed, and is discharged from the discharge port. The compressed air discharged from the discharge port is supplied to the internal combustion engine mentioned above.

The turbocharger 1 further includes a motor 21 (e.g., an assist motor assembly). When the torque of the rotation shaft 14 is insufficient at the time of, for example, acceleration of the vehicle or the like, the motor 21 applies torque to the rotation shaft 14 so as to compensate for the insufficiency. The motor 21 is, for example, a brushless AC motor, and includes a rotor 25 that is a rotating element and a stator 27 that is a fixed element. A battery of the vehicle can be used as a drive source of the motor 21. At the time of deceleration of the vehicle, the motor 21 may perform regenerative power generation by rotational energy of the rotating body 12. The motor 21 has characteristics capable of coping with high-speed rotation (for example, one hundred thousand to two hundred thousand rpm) of the rotation shaft 14.

The rotor 25 is placed between the bearing 15 and the compressor wheel 7 in the axial direction Da. The rotor 25 is fixed to the rotation shaft 14, and is rotatable together with the rotation shaft 14. The stator 27 is housed in the bearing housing 13, and is placed to surround the rotor 25 in the circumferential direction Dc. The stator 27 includes a plurality of coils and an iron core. When currents are supplied to the coils and the stator 27 generates a magnetic field, force in the circumferential direction Dc acts on a permanent magnet 29 of the rotor 25 due to the magnetic field, and as a result torque is applied to the rotation shaft 14.

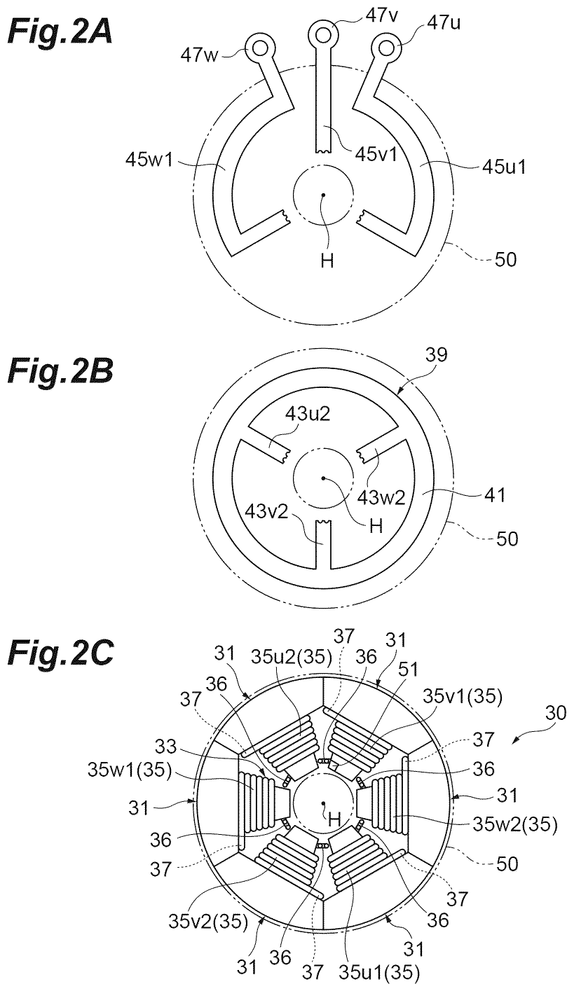

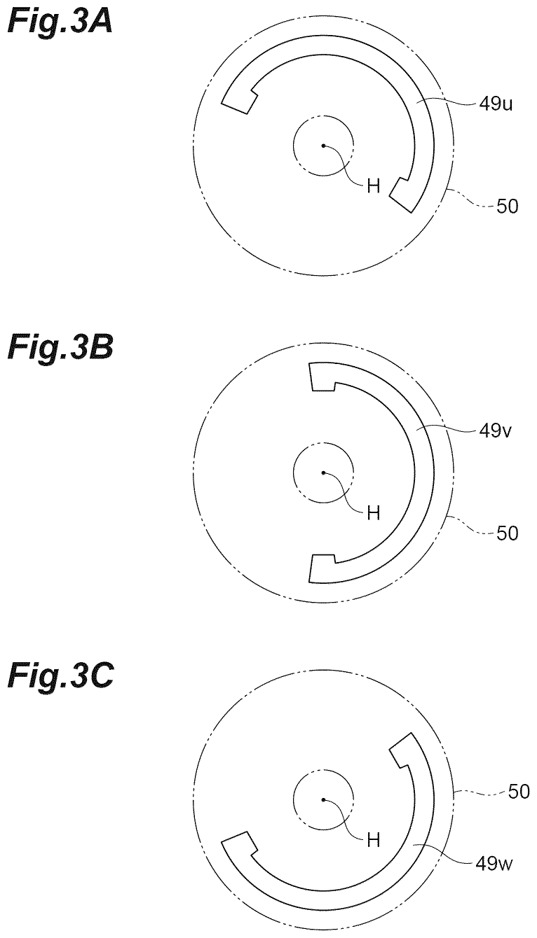

The stator 27 will now be described in more detail. FIGS. 2A, 2B, 2C and FIGS. 3A, 3B, 3C may be understood to collectively illustrate exploded views of main component groups of the stator 27. The direction orthogonal to the drawing sheet of FIGS. 2A, 2B, 2C and 3A, 3B,3C is the axial direction Da; the far side of the drawing sheet is the turbine 2 side, and the near side of the drawing sheet is the compressor 3 side. In the stator 27, the component group shown in FIG. 2B is placed to be stacked on the near side of the drawing sheet of the component group shown in FIG. 2C, and the component group shown in FIG. 2A is placed to be stacked on the near side of the drawing sheet of the component group shown in FIG. 2B. Further, the component group shown in FIG. 3A is placed to be stacked on the far side of the drawing sheet of the component group shown in FIG. 2C, the component group shown in FIG. 3B is placed to be stacked on the far side of the drawing sheet of the component group shown in FIG. 3A, and the component group shown in FIG. 3C is placed to be stacked on the far side of the drawing sheet of the component group shown in FIG. 3B.

FIG. 2C shows a main body unit 30 of the stator 27. The main body unit 30 includes six electromagnet assemblies 31 arranged to surround the rotor 25 (FIG. 1). The electromagnet assemblies 31 are housed in, for example, a circular metal casing, and are arranged at equal intervals in the circumferential direction Dc at a pitch of 60°. The electromagnet assembly 31 includes a core tooth unit 33 extending toward the inner side in the radial direction Dr and a coil 35 wound around the core tooth unit 33. The coil 35 is composed of a set of two round wires, the manner of winding the coil 35 is concentrated winding, and the number of windings of the coil 35 is 5.5 turns. Of the coil ends of the coil 35, a first (e.g., inner) coil end 36 located on the inner side in the radial direction Dr is drawn out from the core tooth unit 33 to the compressor side (the near side of the drawing sheet of FIG. 2), and a second (e.g., outer) coil end 37 located on the outer side in the radial direction Dr is drawn out from the core tooth unit 33 to the turbine side (the far side of the drawing sheet of FIG. 2).

The stator 27 is a three-phase six-slot stator, and the six coils 35 are composed of a first U-phase coil 35u1, a second U-phase coil 35u2, a first V-phase coil 35v1, a second V-phase coil 35v2, a first W-phase coil 35w1, and a second W-phase coil 35w2. In the main body unit 30, for these coils, the first V-phase coil 35v1, the second W-phase coil 35w2, the first U-phase coil 35u1, the second V-phase coil 35v2, the first W-phase coil 35w1, and the second U-phase coil 35u2 are arranged in this order clockwise in FIG. 2. An SPM one-polar-pair motor rotor is used as the rotor 25 for such a stator 27.

A neutral point bus bar 39 shown in FIG. 2B is installed on the compressor side of the main body unit 30. The neutral point bus bar 39 includes an annular portion 41 installed on a peripheral edge portion of the main body unit 30, and three connection bus bars 43u2, 43v2, and 43w2 extending from the annular portion 41 to the inner peripheral side in a cantilever manner. The connection bus bar 43u2 is connected to the coil end 36 of the second U-phase coil 35u2, the connection bus bar 43v2 is connected to the coil end 36 of the second V-phase coil 35v2, and the connection bus bar 43w2 is connected to the coil end 36 of the second W-phase coil 35w2. The connection bus bars 43u2, 43v2, and 43w2 are arranged at equal intervals in the circumferential direction Dc at a pitch of 120°. The connection bus bar 43u2, as viewed from the axial direction Da, extends in the radial direction Dr in a position between the second U-phase coil 35u2 and the first W-phase coil 35w1. The connection bus bar 43v2, as viewed from the axial direction Da, extends in the radial direction Dr in a position between the second V-phase coil 35v2 and the first U-phase coil 35u1. The connection bus bar 43w2, as viewed from the axial direction Da, extends in the radial direction Dr in a position between the second W-phase coil 35w2 and the first V-phase coil 35v1.

Further, three lead-out bus bars 45u1, 45v1, and 45w1 shown in FIG. 2A are installed on the compressor side of the neutral point bus bar 39. One end of the lead-out bus bar 45u1 is connected to the coil end 36 of the first U-phase coil 35u1, one end of the lead-out bus bar 45v1 is connected to the coil end 36 of the first V-phase coil 35v1, and one end of the lead-out bus bar 45w1 is connected to the coil end 36 of the first W-phase coil 35w1. The other ends of the three lead-out bus bars 45u1, 45v1, and 45w1 form input terminals 47u, 47v, and 47w that accept input of currents from the outside, and protrude more on the outer peripheral side than the main body unit 30 and are exposed to the outside of the stator 27.

The lead-out bus bar 45u1 connects the input terminal 47u and the coil end 36 of the first U-phase coil 35u1 via an arc portion along the peripheral edge portion of the main body unit 30. As viewed from the axial direction Da, a portion on the coil end 36 side of the lead-out bus bar 45u1 extends in the radial direction Dr in a position between the first U-phase coil 35u1 and the second W-phase coil 35w2. The lead-out bus bar 45v1 connects the input terminal 47v and the coil end 36 of the first V-phase coil 35v1 almost in a straight line manner. As viewed from the axial direction Da, a portion on the coil end 36 side of the lead-out bus bar 45v1 extends in the radial direction Dr in a position between the first V-phase coil 35v1 and the second U-phase coil 35u2. The lead-out bus bar 45w1 connects the input terminal 47w and the coil end 36 of the first W-phase coil 35w1 via an arc portion along the peripheral edge portion of the main body unit 30. As viewed from the axial direction Da, a portion on the coil end 36 side of the lead-out bus bar 45w1 extends in the radial direction Dr in a position between the first W-phase coil 35w1 and the second V-phase coil 35v2.

As shown in FIGS. 3A to 3C, three crossover bus bars 49u, 49v, and 49w are installed to be stacked on the turbine side of the main body unit 30. The crossover bus bar 49u connects the coil end 37 of the first U-phase coil 35u1 and the coil end 37 of the second U-phase coil 35u2 via a semi-arc portion along the peripheral edge portion of the main body unit 30. The crossover bus bar 49v connects the coil end 37 of the first V-phase coil 35v1 and the coil end 37 of the second V-phase coil 35v2 via a semi-arc portion along the peripheral edge portion of the main body unit 30. The crossover bus bar 49w connects the coil end 37 of the first W-phase coil 35w1 and the coil end 37 of the second W-phase coil 35w2 via a semi-arc portion along the peripheral edge portion of the main body unit 30.

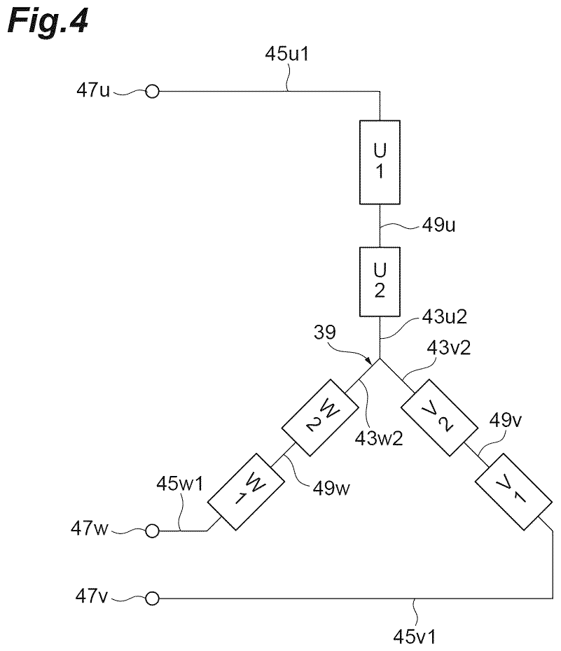

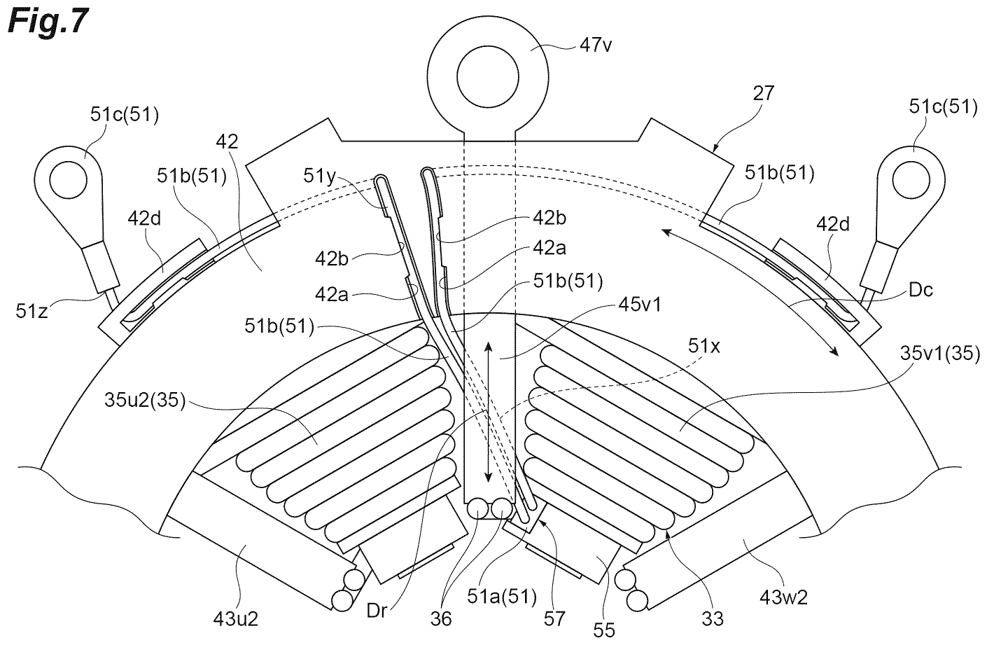

Each of the neutral point bus bar 39, the lead-out bus bars 45u1, 45v1, and 45w1, and the crossover bus bars 49u, 49v, and 49w described above is made of an integrally formed copper plate material, and extends in a plane almost orthogonal to the axial direction Da. When such bus bars are being placed to be stacked in the axial direction Da on the main body unit 30, an electrically insulating layer is interposed between each bus bar and the electromagnet assembly 31 and between bus bars. For example, in an example shown in FIG. 7, the neutral point bus bar 39, the lead-out bus bars 45u1, 45v1, and 45w1, and a resin holder (e.g., a ring-shaped insulating resin unit 42) in which these bus bars are embedded are integrally molded. The insulating resin unit 42a extends in the circumferential direction Dc. Part of the insulating resin unit 42 enters the space between bus bars, etc., and functions as the electrically insulating layer mentioned above. With the component groups shown in FIGS. 2 and 3 described above, a Y-connected two-series stator 27 like that shown in the circuit diagram of FIG. 4 is configured.

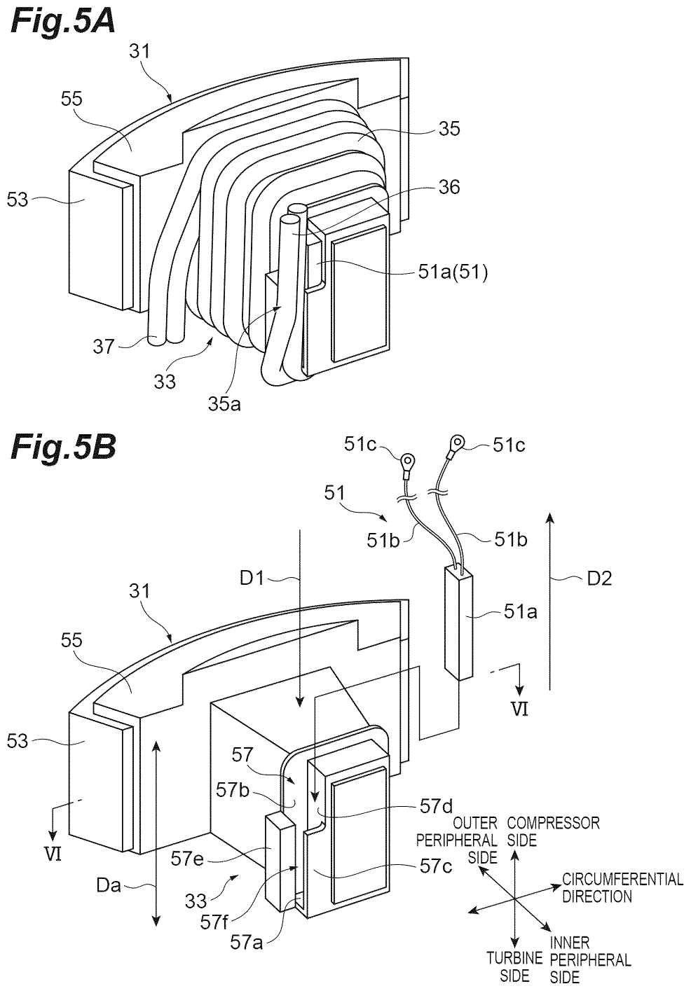

In the stator 27 during operation, when the coil 35 has high temperature, a malfunction such as a short circuit occurring due to damage to an insulating coating occurs; thus, it may be controlled the temperature of the coil 35. For this temperature control, a thermistor 51 is mounted on the stator 27. The thermistor 51 is attached to the core tooth unit 33 of one electromagnet assembly 31. The thermistor 51 (see FIG. 5B) includes a temperature sensing device (e.g., temperature-sensitive element unit 51a) having an elongated rectangular parallelepiped shape, two signal cables 51b (e.g., a first signal cable 51b and a second signal cable 51b) extending from one end surface in the longitudinal direction of the temperature-sensitive element unit 51a, and a crimp terminal 51c provided at an end of each signal cable 51b and configured for connection to the outside.

The components shown in FIGS. 2 and 3 described above are integrally assembled, in this state all the components are fixed by resin molding, and the input terminals 47u, 47v, and 47w and the two crimp terminals 51c are exposed to the outside from a mold resin 50. As a technique of the above resin molding processing, for example, transfer molding, potting, or the like is used.

A structure in which the thermistor 51 is installed in the stator 27 will now be described.

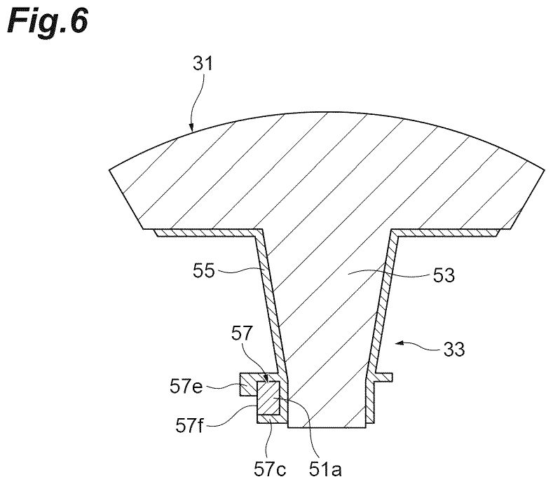

FIG. 5A is a perspective view illustrating, among the six electromagnet assemblies 31 described above, one electromagnet assembly 31 in which the thermistor 51 is installed. FIG. 5B is a perspective view illustrating a state where the coil 35 is removed from the electromagnet assembly 31. FIG. 6 is a cross-sectional view taken along line VI-VI in FIG. 5B.

As shown in FIGS. 5B and 6, the electromagnet assembly 31 includes a stator core 53 that is an iron core and a resin insulator 55 provided to cover a surface of the stator core 53. The stator core 53 and the insulator 55 are integrally formed by, for example, insert molding. The insulator 55 functions as a guide for winding the coil 35, and also functions as an electric insulating portion between the stator core 53 and the coil 35. In the core tooth unit 33, the periphery of the stator core 53 is completely covered with the insulator 55, and the coil 35 is wound around the insulator 55.

In a distal end portion (an end portion on the inner peripheral side) of the core tooth unit 33, the insulator 55 is provided with a pocket 57 for installing the thermistor 51. The pocket 57 is formed to cut out part of an end portion on the inner peripheral side of the insulator 55. The temperature-sensitive element unit 51a is inserted into the pocket 57 in the axial direction Da from the compressor side toward the turbine side. The temperature-sensitive element unit 51a comes to the end at a pocket bottom surface 57a on the turbine side, and is housed in an attitude in which the longitudinal direction is directed in the axial direction Da.

Before the resin molding processing described above is performed, displacement to the turbine side of the temperature-sensitive element unit 51a is restricted by the pocket bottom surface 57a. On the other hand, the pocket 57 has no part that restricts movement on the compressor side of the temperature-sensitive element unit 51a, and the temperature-sensitive element unit 51a can be extracted from the interior of the pocket 57 to the compressor side. The pocket 57 has wall-shaped parts 57b and 57c that restrict displacement in the radial direction Da of the temperature-sensitive element unit 51a, and a wall surface 57d and a restriction part 57e that restrict displacement in the circumferential direction Dc of the temperature-sensitive element unit 51a. Therefore, before resin molding processing is performed, displacement in the radial direction Dr and the circumferential direction Dc of the temperature-sensitive element unit 51a is restricted. A gap 57f is formed in the radial direction Dr between the restriction part 57e and the wall-shaped part 57b, and in the range of the width of the gap 57f, the temperature-sensitive element unit 51a is exposed in the circumferential direction Dc over the entire longitudinal direction.

As shown in FIG. 5A, a coil end portion 35a on the coil end 36 side of the coil 35 passes through the turbine side of the pocket bottom surface 57a, is bent toward the compressor side, and extends in the axial direction Da along the gap 57f mentioned above. The coil end portion 35a is adjacent in the circumferential direction Dc to the temperature-sensitive element unit 51a through the gap 57f. That is, the coil end portion 35a is close to the temperature-sensitive element unit 51a through the gap 57f. The coil end portion 35a may be in contact with the temperature-sensitive element unit 51a. The restriction part 57e may function as a guide for the coil end portion 35a.

The above is a description of the configuration of the electromagnet assembly 31 in which the thermistor 51 is installed (FIGS. 5A, 5B and 6). In contrast, each of the other electromagnet assemblies 31 in which the thermistor 51 is not installed may be different only in that the pocket 57 is not formed, and otherwise has a similar configuration; thus, a repeated description is omitted. However, pockets 57 may be formed in all the six electromagnet assemblies 31 in total, including the other electromagnet assemblies 31 in which the thermistor 51 is not installed. This case is preferable in that the components can be standardized among all the electromagnet assemblies 31.

FIG. 7 is an enlarged view of the vicinity of the thermistor 51 in the stator 27 immediately before resin molding processing is performed, as viewed in the axial direction Da from the compressor side. Herein, it is assumed that the thermistor 51 is installed in the electromagnet assembly 31 in which the first V-phase coil 35v1 is configured. As shown in the drawing, the temperature-sensitive element unit 51a of the thermistor 51 is housed in the pocket 57 of the insulator 55 of the electromagnet assembly 31. As viewed from the axial direction Da, the temperature-sensitive element unit 51a is present in a position slightly shifted in the circumferential direction Dc from the lead-out bus bar 45v1. For example, in FIG. 7, the temperature-sensitive element unit 51a is located shifted slightly to the right side from the lead-out bus bar 45v1. The end surface on the compressor side of the temperature-sensitive element unit 51a is located more on the turbine side than the lead-out bus bar 45v1.

The two signal cables 51b of the thermistor 51 are drawn out from the end surface on the compressor side of the temperature-sensitive element unit 51a, and extend to cross the position of the lead-out bus bar 45v1 as viewed from the axial direction Da. The temperature-sensitive element unit 51a, which is illustrated in FIG. 5B, is inserted in the first direction D1 along the rotation shaft (14). The signal cable 51b is drawn out from the temperature-sensitive element unit 51a in a second direction D2, which is opposite to the first direction D1. In a portion (e.g., a first portion 51x) where the signal cables 51b cross the lead-out bus bar 45v1, the two signal cables 51b pass through the turbine side of the lead-out bus bar 45v1. Further distal end sides of the two signal cables 51b are fitted individually into two grooves 42a provided in the insulating resin unit 42. In the signal cable 51b, the portion that is fitted into the groove 42a is, for example, a second portion 51y. The groove 42a is formed in the end surface on the compressor side of the insulating resin unit 42, and is located more on the left side in FIG. 7 than the lead-out bus bar 45v1. The groove 42a extends in the radial direction Dr. The groove 42a has a claw 42b for holding the signal cable 51b in the groove 42a. By being fitted into the groove 42a having such a claw 42b, the signal cable 51b is prevented from easily lifting towards the compressor side from the insulating resin unit 42.

Further distal end sides of the two signal cables 51b are drawn out to the outer peripheral surface of the insulating resin unit 42 through insertion holes provided in end portions on the outer peripheral side of the grooves 42a. Then, the signal cables 51b extend on mutually opposite sides on the outer peripheral surface of the insulating resin unit 42. A cable holding unit 42d that holds the signal cable 51b is provided on the outer peripheral surface of the insulating resin unit 42. The cable holding unit 42d is provided with a groove equipped with a claw similarly to the groove 42a, and the signal cable 51b is fitted into and held in the groove.

Further, the cable holding unit 42d provides guidance for bending of a distal end portion of the signal cable 51b. The distal end portion of the signal cable 51b is held and guided by the cable holding unit 42d and is bent from the outer peripheral surface to the outside, and the crimp terminal 51c is provided at the distal end portion (e.g., a cable end portion 51z). The vicinity of the bent portion of the signal cable 51b held by the cable holding unit 42d is covered with a heat shrinkable tube in advance. The rigidity of the signal cable 51b is enhanced in the vicinity of the bent portion by the covering of the heat shrinkable tube, and the bent shape of the bent portion is maintained by the rigidity of the signal cable 51b. Thus, the position of the crimp terminal 51c is maintained in a position slightly on the outer peripheral side of the cable holding unit 42d by the rigidity of the signal cable 51b. This position is adjusted in accordance with the position of an external plug to which the crimp terminal 51c is to be bolted, and therefore workability when bolting the crimp terminal 51c to the external plug is improved. The second portion 51y of the signal cable 51b is located between the first portion 51x and a cable end portion 51z.

After as described above the temperature-sensitive element unit 51a is housed in the pocket 57 to be temporarily fixed and the signal cables 51b are drawn around, the resin molding processing described above is performed. By the resin molding processing, the temperature-sensitive element unit 51a and the signal cables 51b of the thermistor 51 are embedded in the mold resin 50 (FIG. 2), and are fully fixed.

In some examples, the signal cable 51b is not fixed to the insulating resin unit 42 by the cable holding unit 42d as described above. for example, the signal cable 51b may not be fixed in the housing of the turbocharger 1. In that case, the insulating resin unit 42 may be omitted. Further, the thermistor 51 may include a connector of a predetermined structure in place of the crimp terminal 51c, and may be connected to the outside via the connector.

The operation and effect of the turbocharger 1 including the stator 27 described above will now be described in further detail.

Before execution of resin molding processing, if temporary fixing of the thermistor 51 is weak, the position of the thermistor 51 may be shifted due to external force generated during assembly or resin molding. In this regard, in the configuration of the stator 27, by the presence of the pocket 57 that houses the temperature-sensitive element unit 51a of the thermistor 51, the temperature-sensitive element unit 51a is temporarily fixed to a distal end portion of the core tooth unit 33 with reliability before execution of resin molding processing.

In this temporarily fixed state, the temperature-sensitive element unit 51a can be displaced in the axial direction Da to the compressor side with respect to the pocket 57. In this regard, the signal cable 51b drawn out from the temperature-sensitive element unit 51a to the compressor side crosses the lead-out bus bar 45v1 as viewed from the axial direction Da, and in the portion crossing the lead-out bus bar 45v1, passes more on the temperature-sensitive element unit 51a side than the lead-out bus bar 45v1. In this structure, displacement to the compressor side of the signal cable 51b is prevented by the lead-out bus bar 45v1.

Accordingly, also displacement to the compressor side of the temperature-sensitive element unit 51a is difficult, and movements such as the temperature-sensitive element unit 51a coming out of the pocket 57 are prevented. Therefore, even when external force generated during assembly or resin molding acts, the temperature-sensitive element unit 51a is reliably held in the pocket 57, and the possibility of occurrence of positional deviation is low.

The pocket 57 for thus temporarily fixing the temperature-sensitive element unit 51a is formed to cut out part of an end portion on the inner peripheral side of the insulator 55, and there may be no need to use another attachment component or the like for fixing the temperature-sensitive element unit 51a. Further, for prevention of coming-out of the temperature-sensitive element unit 51a from the pocket 57, the existing lead-out bus bar 45v1 is used, and there may be no need to use another attachment component or the like. Therefore, the installation space can be reduced as compared to the case where the temperature-sensitive element unit 51a is attached using another attachment component.

Further, the work is simpler and the manufacturing cost is lower than in the case where the temperature-sensitive element unit 51a is attached using another attachment component. If the temperature-sensitive element unit 51a is attached using an adhesive or the like, temporary fixing of the temperature-sensitive element unit 51a may not be stable due to variations in adhesive strength. In contrast, in the stator 27 described in FIG. 7, the temperature-sensitive element unit 51a is temporarily fixed in a more stable manner, and also the work is simplified. Further, since the curing time of the adhesive may not be necessary and also the takt time is reduced, the manufacturing cost is reduced.

Further, by the signal cable 51b being fitted into the groove 42a of the insulating resin unit 42, the signal cable 51b does not easily rise from the insulating resin unit 42 to the compressor side even upon receiving external force generated during assembly or resin molding. Therefore, the position of the signal cable 51b is reliably maintained until fixed by resin molding processing, and an event that part of the signal cable 51b is exposed to the outside of the mold resin 50 is suppressed.

In the motor 21 of this type of turbocharger 1, the inner peripheral side of the stator 27 tends to have high temperature because of being away from a cooling water path placed on the outside of the stator 27, being near the rotating rotor 25, etc. Thus, the temperature-sensitive element unit 51a of the thermistor 51 is preferably installed on the inner peripheral side of the stator 27. In this regard, since the pocket 57 is provided in a distal end portion of the core tooth unit 33, the temperature-sensitive element unit 51a can be placed on the inner peripheral side of the stator 27.

Further, a mold resin 50 is formed in the stator 27 by resin molding processing, and the space between the temperature-sensitive element unit 51a and the coil 35 is filled with the mold resin 50. Therefore, the heat of the coil 35 is transferred to the temperature-sensitive element unit 51a through the mold resin 50, and the temperature-sensitive element unit 51a can detect the heat of the coil 35 to be controlled.

In order to detect the temperature of the coil 35 as directly as possible, the temperature-sensitive element unit 51a of the thermistor 51 is preferably installed close to the coil 35. In this regard, the coil end portion 35a extends in the axial direction Da in a position adjacent in the circumferential direction De to the pocket 57. Therefore, the temperature-sensitive element unit 51a can be installed close in the circumferential direction Dc to the coil end portion 35a, and the temperature of the coil 35 can be detected with good sensitivity. Further, the gap 57f described above is formed in the pocket 57, and the coil end portion 35a and the temperature-sensitive element unit 51a are close to each other through the gap 57f. The coil end portion 35a may be in contact with the temperature-sensitive element unit 51a. Thus, the gap 57f contributes to the temperature-sensitive element unit 51a detecting the temperature of the coil 35 as directly as possible.

It is to be understood that not all aspects, advantages and features described herein may necessarily be achieved by, or included in, any one particular example. Indeed, having described and illustrated various examples herein, it should be apparent that other examples may be modified in arrangement and detail

For example, although some examples are described on the assumption that the far side of the drawing sheet in FIGS. 2 and 3 is the turbine side and the near side of the drawing sheet is the compressor side, the turbine side and the compressor side in this case may be reversed. Further, although in some examples, the temperature-sensitive element unit 51a is installed in the electromagnet assembly 31 in which the first V-phase coil 35v1 is configured, the temperature-sensitive element unit 51a may be installed in any of the six electromagnet assemblies 31. Further, the bus bar crossed by the signal cable 51b may be any of the lead-out bus bars 45u1, 45v1, and 45w1 and the connection bus bars 43u2, 43v2, and 43w2, and may be determined according to the position of the electromagnet assembly 31 in which the temperature-sensitive element unit 51a is to be installed.

Further, although in some examples, the thermistor 51 is installed in one of the six electromagnet assemblies 31 of the stator 27 is described, for example, thermistors 51 may be installed individually in a plurality of electromagnet assemblies 31, and a total of six thermistors 51 may be installed individually in all the electromagnet assemblies 31.

Some additional examples are disclosed as follows, with continued reference to the drawings for convenience of description.

An example turbocharger 1 includes an assist motor assembly 21 having a rotor 25 located on a rotation shaft 14 coupling a turbine impeller 6 and a compressor impeller 7, and a stator 27 located around the rotor 25. The stator 27 includes a stator core 53, an insulator 55 provided around the stator core 53, a coil 35 wound around the insulator 55, a bus bar 45v1 connected to an inner coil end 36 of the coil 35 and a temperature measurement device 51. The temperature measurement device 51 includes a temperature-sensitive element unit 51a located next to the inner coil end 36 and configured to detect a temperature of the coil 35 and a signal cable 51b extending from the temperature-sensitive element unit 51a. The temperature-sensitive element unit 51a is located in an element pocket 57 provided in the insulator 55. The signal cable 51b extends away from the element pocket 57 and crosses behind the bus bar 45v1 as viewed from an axial direction Da of the rotation shaft 14.

In the turbocharger 1, the temperature-sensitive element unit 51a may be inserted in a first direction D1 along the rotation shaft 14. The signal cable 51b may extend out from the temperature-sensitive element unit 51a in a second direction D2, which is opposite to the first direction.

The turbocharger 1 may include an insulating material 42 located next to an outer coil end 37 of the coil 35, wherein the insulating material 42 includes a groove 42a. The bus bar 45v1 may extend from the insulating material 42 to the inner coil end 36. The signal cable 51b may include a first portion 51x that crosses behind the bus bar 45v1, a cable end portion 51z located outside of the stator 27 and a second portion 51y located between the first portion 51x and the cable end portion 51z. The second portion 51y may be fitted into the groove 42a.

The turbocharger 1 may include a second signal cable 51b connected to the temperature-sensitive element unit 51a. The turbocharger 1 may include a first electromagnet assembly 31 and a second electromagnet assembly 31 arranged in a circumferential direction Dc of the rotation shaft 14. Each of the first electromagnet assembly 31 and the second electromagnet assembly 31 may include the stator core 53, the insulator 55, and the coil 35. The bus bar 45v1 may be located between the first electromagnet assembly 31 and the second electromagnet assembly 31, which are adjacent as viewed from the axial direction Da. The second signal cable 51b may extend away from the element pocket 57 of the insulator 55 and crosses behind the bus bar 45vl as viewed from the axial direction Da.

In the turbocharger 1, the inner coil end 36 may extend in the axial direction Da, and is located adjacent to the temperature-sensitive element unit 51a in the element pocket 57, in a circumferential direction of the rotation shaft 14.

The turbocharger 1 may include a mold resin 50 located between the temperature-sensitive element unit 51a and the coil 35.

In the turbocharger 1, the element pocket 57 may include a gap 57f that exposes a part of the temperature-sensitive element unit 51a in the element pocket 57. The coil 35 and the temperature-sensitive element unit 51a may face each other at the gap 57f.

An example turbocharger 1 includes a turbine impeller 6, a rotation shaft 14 fixed to the turbine impeller 6, a motor 21 including a rotor 25 located on the rotation shaft 14, and a stator 27 located around the rotor 25. The stator 27 include a stator core 53, an insulator 55 located around the stator core 53, wherein the insulator 55 includes an element pocket 57, a coil 35 wound around the insulator 55, wherein the coil 35 includes a first (e.g., inner) coil end 36 and a second (e.g., outer) coil end 37, and a temperature sensing device 51a (e.g., temperature sensor or sensor body) located next to the inner coil end 37 and configured to detect a temperature of the coil 35. The temperature sensing device 51a is located in the element pocket 57 and hold by the element pocket 57.

In the turbocharger 1, the stator 27 may include a bus bar 45v1 connected to the inner coil end 36.

The turbocharger 1 may include a resin holder 42 that holds the bus bar 45v1 and that extends in a circumferential direction Dc of the rotation shaft 14.

In the turbocharger 1, the bus bar 45v1 may include an input terminal 47v. The resin holder 42 may be located between the input terminal 47v and the inner coil end 36.

In the turbocharger 1, the stator 27 may include a signal cable 51b connected to the temperature sensing device 51a. The signal cable 51b may extend away from the element pocket 57 of the insulator 55 and crosses the bus bar 45v1 as viewed from an axial direction Da of the rotation shaft 14.

In the turbocharger 1, temperature sensing device 51a extends along the axial direction Da.

The turbocharger 1 may include a compressor impeller 7. The rotation shaft 14 may be coupled to the turbine impeller 6 and the compressor impeller 7.

An example turbocharger 1 includes a turbine impeller 6, a rotation shaft 14 fixed to the turbine impeller 6, a motor 21 including a rotor 25 located on the rotation shaft 14, and a stator 27 located around the rotor 25. The stator 27 include a stator core 53, an insulator 55 located around the stator core 53, wherein the insulator 55 includes an element pocket 57, a coil 35 wound around the insulator 55, a temperature sensing device 51a configured to detect a temperature of the coil 35 and a signal cable 51b connected to the temperature sensing device 51a. The temperature sensing device 51a is located in the element pocket 57.

The turbocharger 1 may include a bus bar 45v1 that is connected to the coil 35 and that extends in a radial direction Da of the rotation shaft 14.

In the turbocharger 1, the signal cable 51b crosses the bus bar 43v1 as viewed from the axial direction Da.

The turbocharger 1 may include a resin holder 42 extending in a circumferential direction Dc of the rotation shaft 14. The resin holder 42 may include a cable holding unit 42d holding the signal cable 51b.

In the turbocharger 1, the cable holding unit 42d may include a groove that extends in a radial direction Dr of the rotation shaft 14. The signal cable 51b may be routed through the groove 42a.

In the turbocharger 1, the groove 42a may include a claw 42b holding the signal cable 51b located in the groove 42a.

What is claimed is:

1. A turbocharger comprising:
an assist motor assembly including a rotor located on a rotation shaft coupling a turbine impeller and a compressor impeller, and a stator located around the rotor,
wherein the stator includes:
a stator core;
an insulator provided around the stator core;
a coil wound around the insulator;
a bus bar connected to an inner coil end of the coil; and
a temperature measurement device including:
a temperature-sensitive element unit located next to the inner coil end and configured to detect a temperature of the coil; and
a signal cable extending from the temperature-sensitive element unit,
wherein the temperature-sensitive element unit is located in an element pocket provided in the insulator, and
wherein the signal cable extends away from the element pocket and crosses behind the bus bar as viewed from an axial direction of the rotation shaft.

2. The turbocharger according to claim 1,
wherein the temperature-sensitive element unit is inserted in a first direction along the rotation shaft, and
wherein the signal cable extends out from the temperature-sensitive element unit in a second direction, which is opposite to the first direction.

3. The turbocharger according to claim 1,
further comprises an insulating material located next to an outer coil end of the coil, wherein the insulating material includes a groove; and
wherein the bus bar extends from the insulating material to the inner coil end, and
wherein the signal cable includes:
a first portion that crosses behind the bus bar;
a cable end portion located outside of the stator; and
a second portion located between the first portion and the cable end portion, and
wherein the second portion is fitted into the groove.

4. The turbocharger according to claim 1,
further comprising:
a second signal cable connected to the temperature-sensitive element unit, and
a first electromagnet assembly and a second electromagnet assembly arranged in a circumferential direction of the rotation shaft, wherein each of the first electromagnet assembly and the second electromagnet assembly includes the stator core, the insulator, and the coil,
wherein the bus bar is located between the first electromagnet assembly and the second electromagnet assembly, which are adjacent as viewed from the axial direction, and
wherein the second signal cable extends away from the element pocket of the insulator and crosses behind the bus bar as viewed from the axial direction.

5. The turbocharger according to claim 1, wherein the inner coil end extends in the axial direction, and is located adjacent to the temperature-sensitive element unit in the element pocket, in a circumferential direction of the rotation shaft.

6. The turbocharger according to claim 1, further comprising a mold resin located between the temperature-sensitive element unit and the coil.

7. The turbocharger according to claim 1,
wherein the element pocket includes a gap that exposes a part of the temperature-sensitive element unit in the element pocket, and
wherein the coil and the temperature-sensitive element unit face each other at the gap.

8. A turbocharger comprising:
a turbine impeller;
a rotation shaft fixed to the turbine impeller;
a motor including a rotor located on the rotation shaft, and a stator located around the rotor,
wherein the stator includes:
a stator core;
an insulator located around the stator core, wherein the insulator includes an element pocket;
a coil wound around the insulator, wherein the coil includes an inner coil end and an outer coil end; and
a temperature sensing device located next to the inner coil end and configured to detect a temperature of the coil,
wherein the temperature sensing device is located in the element pocket and hold by the element pocket.

9. The turbocharger according to claim 8, wherein the stator includes a bus bar connected to the inner coil end.

10. The turbocharger according to claim 9, further comprising a resin holder that holds the bus bar and that extends in a circumferential direction of the rotation shaft.

11. The turbocharger according to claim 10,
wherein the bus bar includes an input terminal, and
wherein the resin holder is located between the input terminal and the inner coil end.

12. The turbocharger according to claim 9,
wherein the stator further includes a signal cable connected to the temperature sensing device, and
wherein the signal cable extends away from the element pocket of the insulator and crosses the bus bar as viewed from an axial direction of the rotation shaft.

13. The turbocharger according to claim 12, wherein the temperature sensing device extends along the axial direction.

14. The turbocharger according to claim 8, further comprising a compressor impeller, wherein the rotation shaft is coupled to the turbine impeller and the compressor impeller.

15. A turbocharger comprising:
a turbine impeller;
a rotation shaft fixed to the turbine impeller;
a motor including a rotor located on the rotation shaft, and a stator located around the rotor,
wherein the stator includes:
a stator core;
an insulator located around the stator core, wherein the insulator includes an element pocket;
a coil wound around the insulator;
a temperature sensing device configured to detect a temperature of the coil; and
a signal cable connected to the temperature sensing device,
wherein the temperature sensing device is located in the element pocket.

16. The turbocharger according to claim 15, further comprising a bus bar that is connected to the coil and that extends in a radial direction of the rotation shaft.

17. The turbocharger according to claim 16, wherein the signal cable crosses the bus bar as viewed from an axial direction of the rotation shaft.

18. The turbocharger according to claim 15, further comprising a resin holder extending in a circumferential direction of the rotation shaft, wherein the resin holder includes a cable holding unit holding the signal cable.

19. The turbocharger according to claim 18, wherein the cable holding unit includes a groove that extends in a radial direction of the rotation shaft, and
wherein the signal cable is routed through the groove.

20. The turbocharger according to claim 19, wherein the groove includes a claw holding the signal cable located in the groove.
